(19) United States
(12) Patent Application Publication
(10) Pub. No.: US 2009/0313113 A1
(43) Pub. Date: Dec. 17, 2009

(54) Business method and process for commercial establishments to advertise directly into proprietary closed circuit networks

(76) Inventors: Thomas A. Dye, Austin, TX (US); Blake A. Freeburg, Ausitin, TX (US)

Correspondence Address: Thomas A. Dye, 6621 Candle Ridge Cove, Austin, TX, 78731, US

(21) Appl. No.: 12/456,074

(22) Filed: Jun. 11, 2009

Related U.S. Application Data
(60) Provisional application No. 61/131,988, filed on Jun. 13, 2008.

(51) Int. Cl. G06Q 30/00

(52) U.S. Cl. 705/14.42; 705/14.43; 705/14.45; 705/14.46; 705/14.68; 705/14.69; 715/771; 715/769

(57) ABSTRACT

The present business method transparently embeds advertisements into client browser displays at the edge of the Internet. A closed system of locally owned businesses makes up a network of publication points. The business method uses a simple single page “dashboard” interface to select and publish ad campaigns directly into one or more premises helping to qualify and quantify publication points and advertising subscription purchases. The dashboards display has controls to dynamically update campaign publications and display pricing results. In addition, the method builds and displays custom groups based on location, business types, and customer demographics. Thus, custom grouping options as selected by dashboard users. Subscription pricing is by ad size, type, location, subscription period and discount codes. The dashboard may include additional statistics such as subscription renewal dates and ad convergence information. Advertisers use this business method to target users directly in proximity to the point of sale.

### CROSS-REFERENCE TO RELATED APPLICATIONS

This application is the formal U.S. patent application based on a previous provisional application No. 61/131,988 filed on Jun. 13, 2008 entitled “BUSINESS METHOD AND PROCESS FOR COMMERCIAL ESTABLISHMENTS TO ADVERTISE DIRECTLY INTO PROPRIETARY CLOSED CIRCUIT NETWORKS” whose inventors are Thomas A. Dye and Blake A. Freeburg of Austin, Tex. USA; and the following utility patent application Ser. No. 11/354,604, filed on Feb. 15, 2006, entitled, “SYSTEM AND METHOD FOR DATA INSERTION INTO PASSIVELY MONITORED NETWORK EVENTS” whose inventor is Dye et al, of Austin, Tex. USA; being incorporated herein by reference for all intents and purposes.

This application is also related to the following U.S. Provisional Patent Application No. 60/773,441 first filed on Feb. 15, 2006 entitled “MIXED MODE BUSINESS METHOD FOR TRANSPARENTLY INSERTING COMMERCIAL BRANDING INFORMATION DURING NETWORK EVENT TRANSACTIONS” whose inventor is Dye et al, of Austin, Tex. which expired on Feb. 15, 2007 without formal filing of a follow-on full application; and provisional patent application No. 61/131,987 first filed on Jun. 13, 2008 entitled “SYSTEM AND METHOD USING INTERPRETATION FILTERS FOR COMMERCIAL DATA INSERTION INTO CLIENT COMPUTING DEVICES” whose inventor is Dye et al, of Austin, Tex.; and provisional patent application 61/137,011 first filed on Jul. 25, 2008 entitled “SYSTEM AND METHOD FOR PASSIVE MANIPULATION OF DATA INSERTION INTO CLIENT COMPUTING DEVICES” whose inventor is Dye et al, of Austin, Tex. All references are related to the utility patent application disclosed herein and are being incorporated herein by reference for all intents and purposes. All provisional and formal patent applications have a common assignee and at least one common inventor, and which are herein incorporated by reference in its entirety for all intents and purposes:

| SERIAL | DOCKET | |
|---|---|---|
| NUMBER | NUMBER | TITLE |
| 60/654585 | 66245-001 | SYSTEM AND METHOD FOR DATA INSERTION |
| | | INTO PASSIVELY MONITORED NETWORK |
| | | EVENTS |
| 11/354604 | 66245-101 | SYSTEM AND METHOD FOR DATA INSERTIONS |
| | | INTO PASSIVELY MONITORED NETWORK |
| | | EVENTS |
| 60/773441 | 66246- | MIXED MODE BUSINESS METHOD FOR |
| | PROV002 | TRANSPARENTLY INSERTING COMMERCIAL |
| | | BRANDING INFORMATION DURING NETWORK |
| | | EVENT TRANSACTIONS |
| 61/131987 | 66265- | SYSTEM AND METHOD USING |
| | PROV004 | INTERPRETATION FILTERS FOR COMMERCIAL |
| | | DATA INSERTION INTO CLIENT COMPUTING |
| | | DEVICES |
| 61/137011 | 66285- | SYSTEM AND METHOD FOR PASSIVE |
| | PROV007 | MANIPULATION OF DATA INSERTION INTO |
| | | CLIENT COMPUTING DEVICES |
| Unassigned | 66265-104 | SYSTEM AND METHOD USING |
| | | INTERPRETATION FILTERS FOR COMMERCIAL |
| | | DATA INSERTION INTO CLIENT COMPUTING |
| | | DEVICES |

### BACKGROUND OF THE INVENTION

1. Field of the Invention

The present invention relates to a business method and process in the field of Internet Marketing that effectively uses Internet technology to allow both customers self service and product channel distribution which, in turn allows small and medium sized commercial establishments to effectively advertise through an untapped and unique business method. The business method of the present invention more particularly shows how this new advertising channel is used to customize product and service messaging to greatly enhance the reach of advertising, branding, customer awareness, business prospects and communication effectiveness.

2. Description of the Prior Art

Web based advertising has been employed in a wide variety of environments. From leveraging email (spam) to creating and marketing blogs, to social networking sites that generate “independent” customer product reviews, to Internet marketing techniques that place display ads directly into client browsers, to targeted search advertising. Internet marketing use of display ads continues to find new ways to secure sales. Advertisers have incorporated the open Internet along with new media techniques to capture the eyeballs of many potential customers. In today's market advertisers pay for ad-views (impressions), clicks, links, sidebars, give-a-ways, data-mining, customized targets, and personal information along with many other varieties of ad-ware tools. Prior art business models that target wireless hotspots and other public Internet portals use software technology to direct data traffic through a remote proxy server, typically located off premises, where advertisers push content from one or more web servers to the client (end-user). This business model has been used to “Focus” customers to an unlimited set of advertisements while they “surf” the web connecting to Internet through Internet Access Points located around the world. Customers are typically faced with pop-up or pop-under advertisements that appear in regular time intervals, logon screens requiring personal end user information, framing ads located around top, side or bottom of web-pages (banners) and even personal polling used to extract the potential customers likes and dislikes. Alternate wireless advertising models use browser plug-ins or premises-based appliances that re-direct network connections to one or more remote proxy servers. As such, remote proxy servers may be used to collect various user information and web browsing habits or force patrons to specific web-sites sponsored directly by advertisers and manufactures blocking competitive information and limiting user choice. Other remote proxy models force users to prioritized search results where products and services sold by advertiser sponsors are displayed first. In some prior art business models these remote proxy servers go as far as blocking competitor's information from ever being displayed on client computers.

When it comes to “free” Internet access, some prior art embodiments validate the customer log-in, then prior to “open” Internet access, present the customer with one or more web-sites including advertisements, advertiser landing pages and sales discounts or specials. These prior art methods sometimes require a login requiring a personal email address in order to “authenticate” users. This prior art method stores usernames and passwords required to gain Internet access. The customer profile information (email or address) is often resold for use in other advertising campaigns such as physical mail-outs, customer call lists or email spamming engines. This method of advertising can be relatively ineffective because customers just want fast Internet access without the headache of a long and cumbersome logging in process, not to mention the unwillingness of customers to hand-over personal information. In addition, customers may have already made a purchase and expect free, unencumbered Internet access. The prior art model has a soft Return on Investment (ROI) for business owners and it is very hard to pin-down payback options and which advertisers are using their premises to advertise within. The actual pay-off for Internet access point services in most businesses is either non-existent or considered “the price of doing business” by business owners. It is often considered necessary to compete with competition and to keep the “lack-of-wifi comments” out of the Internet blogs and reviews. Thus, it is desirable to find a business method to provide free Internet access to customers that integrates into the premises owners' main stream of business to allow; increased ROI, improved customer traffic, increased customer product awareness and customer satisfaction without burden of increased costs or limitations on business cash flow.

### DESCRIPTION OF RELATED BUSINESS MODELS

In most premises that provide Internet access, owners pay the cost of wireless installation and broadband services, while others pass the cost on to customers with one or more pay-per-access programs. Lately the market has proven that “open” Internet access is proportional to the cost and ease of getting on-line. The theory is that by offering “free” easy to use Internet access more patrons will use the facilities and buy more goods and services. In some cases this can backfire with customers camping out on computers at the businesses busy times taking up valuable “paying” customers space. Thus it is therefore desirable to have a way to attract customers during non-peak times or seasonally slow periods. The present business method of the preferred embodiment teaches how dynamic Internet advertising that is very location specific may be used to publish time sensitive information directly into the proximity of where goods and services are sold.

Technically speaking, Internet access points typically use wireless routers connected to one port of either a cable modem or DSL modem. The other port of the modem is typically connected through phone wire (twisted pair) or coax cable to one or more Internet Service Providers to obtain the final Internet connection. Most Internet services providers sell and support the necessary hardware and software to enable the access point. Business owners typically contract the installation and IT support for installation and management services directly. They then rely on ISP and broadband providers for their wide area network connection. Some Internet providers may have an all-inclusive model providing broadband services along with the required hardware, software and support. These business models are strictly service models and typically are subscription based for broadband connection to the Internet and various support services. In some cases these business models are solely based on cost of time and materials for the services provided. It is therefore desirable for IT service providers to add value by providing both managed services and advertising revenues to their customers giving them continued and predictable revenue and earnings even after the installation and broadband connections are completed. Thus, it is desirable to have a method where IT professionals can increase their sustainable revenues through alternate sources other than those presented in the traditional prior art methods.

Prior business methods recognize that on one hand it is desirable to provide non-obtrusive and non-offensive Internet ads that do not disrupt or offend customers. On the other, it is desirable to provide a method that allows advertisers to maximize ad space and awareness. The two methods often conflict catching the business owners who provide Internet access points (hotspots) in the middle between higher paybacks for ads and less customer satisfaction because of ads. The prior art usage of wireless advertising displayed on client mobile devices that use Internet access points within an owners premises provides little gain to those business owners. Providing free Internet access is an expense for business owners who must pay both the Internet access and support charges. Furthermore, prior art business methods have focused on large national or international advertiser sponsors that tend to alienate business owners and their customers showing little to no residual value. The large advertisers use ads that are typically from one of many ad network providers providing little to no value to customers and premises owners. Thus, it is desirable to offer a method that adds value for both hotspot owner's and Internet access user's and within that method generate the revenue that supports the cost of services to provide free Internet access.

In the prior art business method, local business advertising has not had the benefit of targeted Internet display advertising within the premises because of the lack of business methods that focuses directly on local advertising in the proximity of the point of sale of goods and services. Since 80% of all retail purchases are made within 10 minutes from work or home both premises owners and consumers benefit from local advertisements instead of multi-tiered Internet ad networks filling web-pages with national ads. The prior art methods do not allow business owners the ability to dynamically publish goods, services, specials and events into their own establishments and do not reduce end user aggravation by transparent and non-intrusive advertising. Prior art methods for providing advertising into Internet access points does not adequately provide advertisers with high valued web-page real estate having high web-page coverage in large display windows with a variety of flexible image formats. Therefore, it is desirable to present a new method for Internet advertising that provides more acceptable advertising in a non-obtrusive method keeping customer satisfaction high but still having the ability to satisfy the “in-your-face” appetite of Internet advertisers. It is also desirable for small and medium business owners, individuals and local retailers to publish Internet display advertising, relevant information and content into nearby “proximity-based” Internet access points.

Various Internet advertiser networks provide ad placement tools to optimize the work necessary to manage Internet advertising placements and pricing as known to one knowledgeable in the prior business methods. In prior Internet advertising methods, ads are typically designed and placed by ad agencies or ad network personnel. With the advent of web-enabled display and search Internet advertising pioneered by various ad networks such as Doubleclick, Google and Yahoo, smaller individual business owners have been granted the ability to publish and monitor “ad-word” advertising techniques. In the prior art business methods, ad networks supply the on-line advertising tools to allow any business large or small to automatically publish, monitor and pay for the advertising services. Search advertising uses input-string text search technology to identify keywords input by users and keywords sold to the highest bidding advertisers. The text-ads are then displayed to the consumers in a rank order of the advertisers with the highest bids. In the prior art business method text-ads that get “clicked-on” pay proceeds to web-page owners who in-turn allow the ad networks access to display advertising on their web-pages. Web-site owners share in the revenues generated by advertisers who advertise on those pages. But, in the prior art methods no residual payments are made to the business owners who provide Internet access on their private Local Area Networks (LANs). Internet text-ads have commercial value based on the number of times ads are clicked by Internet users. The bidding process allows keywords with higher payments to have a higher likelihood of being displayed at the top of the advertisers list on searched web pages and thus have a higher commercial value. Because most smaller and medium sized business can't afford to compete with the larger corporations, they tend to lose-out on the bidding and are typically forced to use keywords that do not fully align with the products or services they sell. While the Keyword method has a proven value, larger in-page ad impressions called “display advertising” is not based on keywords and thus has a different commercial model. While clicks on display ads are still part of the commercial ad value assessment, the size, type, number of user impressions (views) and web-site popularity where ads are displayed often determine the commercial value of this type of Internet advertising. For the purpose of the present invention, the term “body-ad” will be used to describe an individual display ad shown on one or more web-pages in a client browser window. Body-ads are subject to more participation by commercial ad agencies that publish into the larger tier's of ad network providers. Placement agencies are typically paid by larger national & international advertising agencies that maintain corporate accounts. Similar to bidding for keywords in text-ads, the prior art business method typically inhibits the smaller local businesses from participating in Body-Ad display advertising to the same degree as the larger corporate accounts. In addition, smaller local businesses selling goods and services within a local proximity do not typically desire paying for Internet ads that appear outside the proximity of their business. In addition, small to medium businesses may not have the funds to hire ad agencies for Internet ad placements. Smaller local businesses who want to use Internet display marketing to get their messages out are then relegated to Keyword type Internet ads which don't have the impact of full size, in-page, GIF animated or FLASH animation type advertising. Another issue with text ads and traditional display body-ads is the inability to pin-point ads directly to customers in point-of-sale locations. In addition the inability for advertisers to dynamically change display-ads without assistance from ad agencies or ad networks prevents low cost and ease of deployment. Typically, display ad deployment requires contract negotiations and custom placement by agents who typically require payment of 15% of the total display ad marketing budget for doing the ad placement work. Thus, it is desirable to have an automated way to allow large and small business, ad agencies and placement agencies to quickly publish body-ads of different types and sizes directly to the most popular web-sites with easy to use web-based advertising tools. In addition it is desirable to publish ads dynamically into targeted locations within the proximity of buyers and sellers.

In the prior art business method the commercial value of display advertising has been historically based on the number of display ad views and number of times the display ad has been clicked by the consumer. This model is typically measured in cost value by CPM; the cost per thousand ads displayed. The value of a click to the ad sponsor URL is also used under a similar cost structure. The prior art methods of views and clicks forces advertisers under budget constraints to limit the number of display ad views or clicks effectively shutting off the advertising when the money-cap per time period has been reached. In addition, this view and click based accounting system leads to “click-fraud” or misrepresentation of real human eyeballs with automated Internet “robots” that automatically request pages for ad views and programmatically simulate clicks from the browser surface display. Click fraud is a financial loss for advertisers and has been quietly dismissed by all of the display and search advertising networks. Thus, it is highly desirable to dynamically total-up the costs of ad publications in real-time at the time of purchase and sell display advertising as a fixed cost subscription. Also, it is highly desirable to eliminate click fraud from the advertising method. The fixed pricing or “subscription model” also eliminates the need to turn off the advertising pipeline when Internet marketing funds are depleted. Thus, the present business method of using subscription based advertising is preferred. This business method eliminates the variable cost associated with the prior method of accounting by CPM or payments based on clicks, especially in a prior art method where ad accountability and fraud are highly possible.

### BRIEF DESCRIPTION OF THE DRAWINGS

The benefits, features, and advantages of the present business method will become better understood with regard to the following description, and accompanying drawings where:

FIG. 1 Illustrates the single web page user interface used to assign groups of image items into profiles and profile groups into groups of Internet access points;

FIG. 2 illustrates the relationship between ad publication, pricing and the advertisers identification attributes;

### SUMMARY OF PRESENT BUSINESS METHOD

The present business method encompasses the use of ad computing devices preferably located at the edge of the Internet network along with centrally located web servers for control of a unique and easy to use “dashboard” type ad-publishing interface. The interface can dynamically publish information and advertisements into very finely defined geographical areas. The present method uses centrally located servers to capture, organize and deliver content to computing devices preferably located at the networks edge. The present method has the unique ability to pinpoint information delivery directly to customers located within close proximity to the point-of-sale. The method is very different from the prior art “keyword” based Internet marketing with an easy to use web-based interface and flat rate subscription service. This method allows anyone with an Internet connection and computing device to instantly publish rich media information directly into private premises of interest to advertisers. The present method fills a gap created by national ad networks that define the present day Internet marketing methods. It uniquely provides an outlet for business owners and marketing groups to deliver proximity based advertising directly into closed circuit network environments. The present method teaches a method to publish rich Internet media content directly into the body of displayed web-pages without any disruption to the original web content contained on the page. Local ads can now be published into the body of the most popular web sites without the traditional costs of ad placement services or agency fees enabling display advertising to any business that currently is limited to ad-word advertising.

### DETAILED DESCRIPTION OF THE PRESENT BUSINESS METHOD

The business method of the present invention relates to information technology transport between public and private commercial businesses and teaches a business method where public internet access may be provided free of charge to end users over private Local Area Networks. The preferred method is to provide a service to end users, business establishments and advertisers alike that enables use of injected “in-page” body-ads of all types directly into closed captioned proprietary networks. The technology (Ref. U.S. patent application Ser. No. 11/354,604 filed on Feb. 17, 2006, whose inventor is Thomas A. Dye and previously filed provisional application 60/654,585 whose inventor was also Dye et al) uses a combination of proprietary technologies that allowing customer branding, information and advertisements between one or more commercial parties in the form of electronic correspondence. The method automatically injects network events into private networks during real-time data transport between central offices and private Internet access providers. In the business method of the present application electronic correspondence is transparently applied from one or more system appliances connected between one or more local area networks also located within one or more Internet access points. Whereby, at least one or more local (premises based) network appliance is remotely monitored and updated with new information on periodic bases under the direction of one or more centrally located web servers. One or more of the central web-servers (ad-servers) have both public Internet access for subscribers and public or private Internet access to the said premises based network appliance over one or more Wide or Local Area Networks. Thus, such network connections provide the means to modify the transported content between public networks and closed proprietary private networks through at least one or more premises based units providing private Internet access to commercial businesses and end users.

The preferred embodiment of the present business method is suited for wireless or wired connections and is indented to be free of charge to the public. In the preferred method information is embedded into the most pertinent network events (i.e. most popular web-pages) that allow URL tracking, messaging, advertising and branding transparently to one or more client (end user) devices. Such that transparently embedded network events may be injected via HTTP protocol to enable additional information (ads) into emails, Instant messages, text messages, served web-pages and most media data types that are interpreted by commonly used web-browsers or VoIP devices. Examples include HTTP data filtering and injection of network events into Web-enabled devices such as web-pages presented by browser applications on notebook computers or wireless mobile devices. These client devices are connected via one or more proprietary local area network communications structures as known to one knowledgeable in the art. In the preferred embodiment a premises based network appliance positions and injects network events into the HTTP data stream (Ref. Provisional application 61/131,987 first filed on Jun. 13, 2008 and whose inventor is Dye et al). This method is achieved without modification, additional code or client application downloads. Alternate embodiments may include network events injected by a remote proxy server located off-premises. While protocols such as port 80 TCP/IP over IEEE802.x WiFi is the preferred network communications type most known network communication types are applicable to the present method.

The present business method uses a mix-mode go-to-market model. A combination of at least one or more premises based network appliances as describe previously, one or more remote ad servers responsible for advertisement delivery under direction of at least one or more client browser applications and a web-servers used as the advertiser interface for pricing, uploading, sizing and control of advertisements and information published into closed or private network systems provided by Internet access providers. The business method of the preferred embodiment also provides a web-based subscription service that enables advertisers and Internet access providers (premises owners) to create upload and publish advertisements and pertinent information directly into emails, messages, web-pages interpreted by commonly used web-browser applications or mobile devices. Premises owners may use a closed version (exclusive) of this system to promote their own products and services or sell ads to their suppliers, or may choose to allow third parties advertisers typically enabled by one or more ad networks to purchased subscriptions to advertise directly into their premises. Third party advertisers generate ad revenues that are shared with the premises owners.

Local Proxy servers with wireless access point capability (Network appliances) may be sold through a variety of distribution methods. They may sell through Internet storefronts, original equipment manufacturers, information technology specialists, factory representatives, agencies or independent dealers. In the preferred embodiment of the business method appliances are sold into locations at the edge of the network by owner agents who practice in the art of reselling into the Information Technology industry. In addition to network appliances for local connection to the Internet and advertising insertion along with network managed services may be resold by independent sales agents. Web-enabled advertising subscription services are also preferably sold by independent agents who may have experience in selling internet advertising. In addition subscription services may be sold through third party agencies such as ad agencies, placement agencies and other ad network providers. The present business method enables sales affiliates to sell ad subscription services a to end-users, retailers, agencies, dealers, ISPs and local area representatives. Ads are deployed directly to the edge of the Internet network. a “closed-circuit” environment for injected advertising or information events is created by deployment of edge computing devices controlled by one or more central servers. Subscription services include the ability for customers to purchase network appliances, upload images, create advertising campaigns, review charges, adjust and modify purchases, view report and appliance statistics and publish ad campaigns (advertising profiles) directly to the networks edge. A subscriber customer uses a private web-portal account to view pertinent advertising statistics such as number of clicks and impressions on a per-premises basis. Additionally, subscribers can view the number of ads currently running in a single premises or a group of premises. They can download aggregated statistics and determine the amount spent per specific location on ads by competitive businesses. For example, competitive groupings may include the amount of money spent by competitors selling like products or services into specific areas of the distribution network. By allowing competitors to see the amounts spent by pier business, they will tend to compete at higher levels. Thus, this method emulates the prior art method of bidding on key-words to increase ad-value but in a totally different subscription based model.

It is also desirable to group Internet access points so that ads may easily be deployed into business that have like similarities or have proven to be most effective. Typical access points may be grouped by franchise, business type, shopping centers, malls, neighborhoods, subdivisions and public or private institutions by subscribers. Sales agents may be resellers that specialize in selling to any or all of these groups. Internet access points can be grouped by other specific demographics such as postal codes, cities, counties, states or other known landmarks. In the preferred method there exists a pre-defined set of groupings used as the default groupings and user defined groupings customized by each subscriber. Included in the subscriber's web-portal are additional aggregated statistics such as sales conversion numbers and sales targets sorted by ad type. The ratio of ads displayed to sale conversions are based on closed loop methods some of which integrate into the actual point of sale processing. Thus, the preferred embodiment of the present business method uses premises based appliances and Internet technology to enable ad deployment in a dynamic method wherein, ads may be updated or altered in real-time. Publishers (premises owners) may collect revenues and measure their own advertising results enabling ad-value optimization directly to the networks edge and directly to customers in proximity to the point of sale.

The preferred embodiment of the present business method teaches how advertiser items presented on a single web-page (dashboard) can be moved from one area on the page into groups of images (ad campaigns or ad profiles) on the same page and how campaigns can be moved into groups of internet access points while still on the same page. Profiles and Internet access point groups may contain one or more images or access points respectively. The operation of moving image and media (advertising objects) files into advertising profiles (advertising campaigns) and then publishing campaigns into access points is simply accomplished through one or more drag and drop operations.

Within the customer ad-tools web-portal is an optional add-to shopping cart price accumulator. The price is accumulated and displayed as advertisers move one or more ad campaigns into one or more access point groups. The price accumulator also tracks shopping cart items as images for specific campaign groups are moved out or deleted from access point groups. On the same page is a column or array of default grouping categories for the various access point groupings as describe herein. Advertisers may select and categorize individual access points or groups of access points forming customized groups of Internet access points. Access point groups are preferably displayed with web-browser based maps, with all the attributes known to those knowledgeable in web-based graphical mapping display and positioning features. Profiles dragged onto map locations are indicated with push-pin type location indicators.

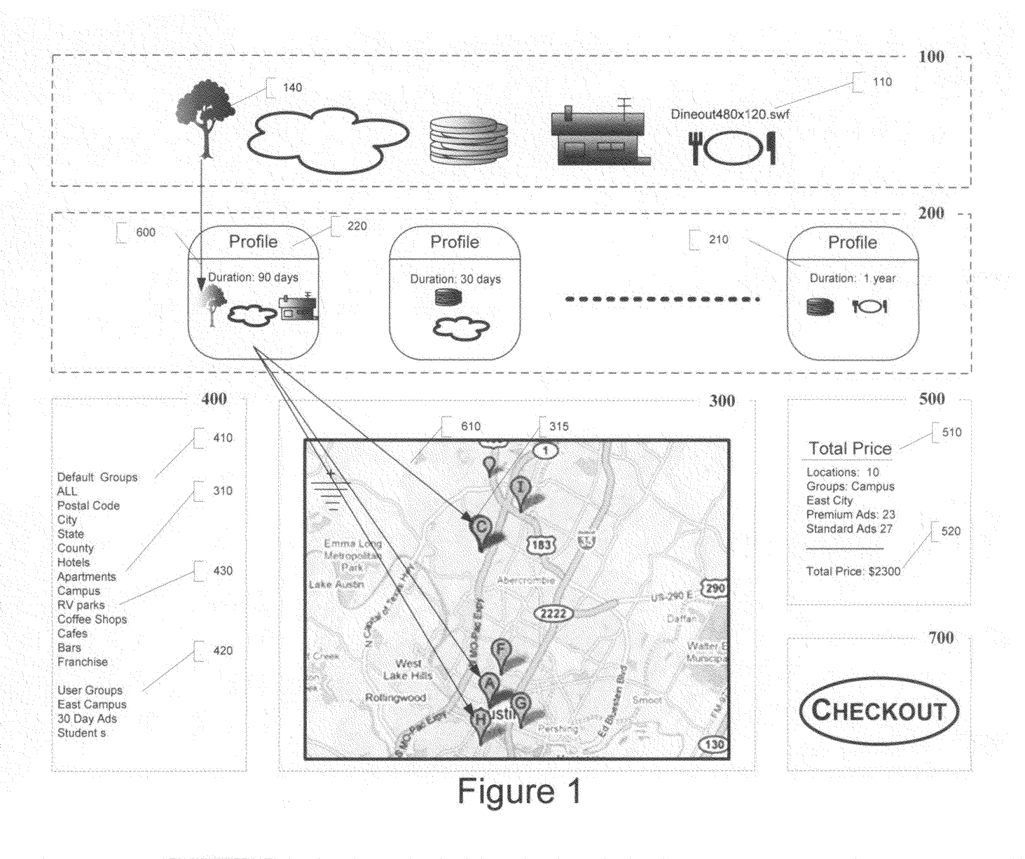

Referring to FIG. 1, an example of the preferred advertiser's single page dashboard for ad creation and publication is illustrated. In the preferred embodiment, a single page advertiser interface is used to simplify the process of ad campaign creation and publication. On the single page dashboard in the preferred embodiment are five main areas. Alternate embodiments may contain more of less areas based on other various requirements. The image in text items area [100] contains previously uploaded images or text to be published into various Internet access points. The subscription profiles area [200] contains at least one or more subscription profiles. The Internet access points map area [300] displays the various access points based on the grouping area [400]. And finally, the price accumulation area [500] tracks and displays various purchase statistics and the final purchase (checkout) price. The illustration of FIG. 1 also shows an optional checkout button [700] to finalize payment and published the selected profiles of images into one or more Internet access points. In the preferred embodiment of FIG. 1, the user manipulates objects between areas of the dashboard with a “drag and drop” interface typically all under control of one or more Internet browser applications as known to one in the art. The dashboard interface allows users to select one or more images and text items (text may be attached to images) into one or more ad profiles (ad campaigns) and position one or more profiles into one or more groups of geographically located Internet access points. To better illustrate the “drag-and-drop” operation of FIG. 1, multiple arrow indicators [600] [610] are placed between the major area blocks. The arrow indicators are used to demonstrate a dynamic “drag and drop” user operation. Wherein users select an object on the dashboard display by moving the cursor over any displayed object then depressing at least one button on the pointing device and holding the button depressed while dragging the object to the desired dashboard placement area and releasing the button where the display cursor is finally positioned. Thus, the “drag and drop” interface is known to most users as the simplest and fastest method to manipulate objects between areas of the dashboard display.

Again referring to FIG. 1, the user process is to select one [140] or more items from the image in text items area [100] and drag [600] one or more items to the subscription profiles area [200] dropping the items into one [220] or more subscription profiles. Each item located in the image in text items area [100] has previously been designed, rendered, created, and scaled to a specific image size and type. Preferably, the image names embed the image resolution and the image extensions indicating the type of object. For example, image types .JPG or .GIF may indicate static compressed images, while types .mov or .swf may indicate movies or animation types. Once profiles [220] are built containing one or more images or text items, the profiles are labeled with a duration attribute [210] indicating the time in which the profile will run (be published for display) in one or more Internet access points. Profiles may then be dragged [610] onto the Internet access point map area [300] and dropped into one or more Internet access points [315] as illustrated in FIG. 1.

FIG. 1 also illustrates the total price accumulation area [500] displaying selection information such as the total number of images, locations, premium and/or standard advertisements, and preferably other information [510] as required to inform the user of the breakdown of possible purchases based on images sizes, subscription periods and number of profiles deployed into one or more Internet access points. This area [500] tracks the user's purchase selections as items are dragged, dropped, or deleted from the Internet access point map [300]. Also in the total price accumulation area [500] is the total price [520] as represented by the selections dropped into the Internet access point map area [300]. Price allocations and selected items as shown in the total price area [500] are dynamic and tracked in real-time during the advertisers selection and manipulation of ad objects.

Again referring to FIG. 1, the default-grouping list [400] shows default groups of related Internet access points. The default-grouping list [400] may contain both default groups [410] and user created groups [420]. As defined by the preferred embodiment of this method, default groupings [410] are the most commonly used groups of Internet access points. User created groupings [420] allow the user to design a custom group, name it and assign Internet access points from a list of access points currently displayed. The default groupings are by location and business types and are based on certain criteria and demographics. User created groups may be saved and further reference at a later time. Users may select either the default groupings or the user created groupings from the groupings area [400]. During the groupings selection process [310] and assignment into the access point map area [300], the Internet access point map area [300] is dynamically re-rendered to illustrate the most current groupings as selected by the user. For example, in the illustration of FIG. 1, the user selects apartments [310] from the groupings area [400] default groups [410]. After selection the corresponding web-server re-renders and displays all the apartment locations within the geographical area presently being viewed by the user. Geographical areas may be zoomed in or out and paned left, right, up or down as commonly known in the art. Drag and drop performance may be by individual access point or by one of more of the groupings. The user may drag one or more profiles into one or more locations or simply hold down a keyboard control character to drag and drop a profile into all the hotspot locations within a specific grouping. For example, the RV-parks selection [430] in the default groupings list [400] would render to the access point map all the enabled RV parks capable of Internet ad injection within the current map view. A profile of items may be published to all the RV parks in the current map view simply by holding a keyboard key during the drag and drop operation. To obtain more information about a single access point a simple mouse-over of the cursor on any map [300] point of interest will yield additional information in a pop-up fashion for any of the individual access points [315].

The preferred embodiment of the present method uses a multidimensional structure for pricing and categorizing access point purchases. In the present embodiment each ad image or animation file (advertising object) has an ad Identification attribute (ADID) which is the lowest common denominator element that holds a number of components used to determine the final advertising monetary value often referred to as the total pricing. In the preferred embodiment there may be many file name extensions wherein “advertising object” is used to represent one of a plethora of different image or animation files and file extension types as known to one knowledgeable in the art. Each ADID attribute contains the 2D resolution in pixels (X/Y size), the type of ad format (extension), the ad access point location (access point ID), the publication time and a fractional multiplier for volume price scaling and discounts. The ADID attribute field is used as an index into the pricing matrix to display [500] the accumulated price as profile groups are added and deleted from the various groupings [400] or Internet access point locations [300].

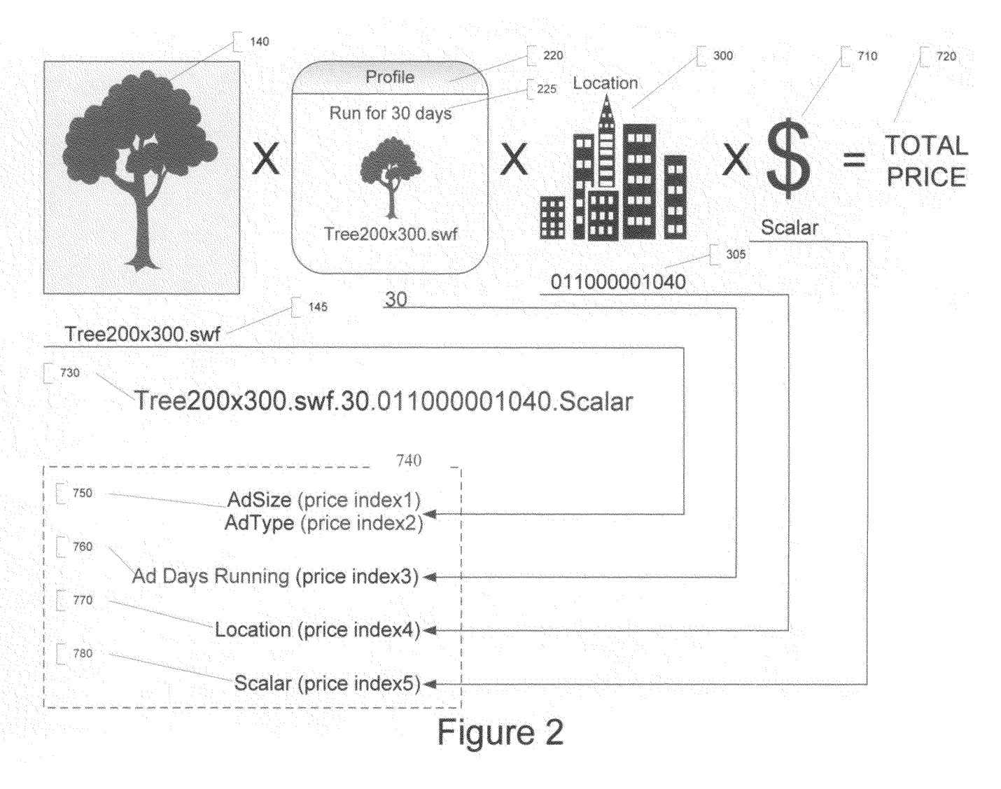

FIG. 2 shows the illustration of the preferred method using a multidimensional structure for pricing and categorizing purchases. In the figure image or animation items [140] are priced using total resolution (number of total pixels) based on the horizontal and vertical dimensions and the extension type [145] of image or animation to be published. The extension type is indicated by the filename extension name as known to one knowledgeable in the art. In the example as illustrated in FIG. 2, an image item [140] with the filename Tree200×300.swf [145] with the name “TREE” and the resolution “200×300” along with the file extension “SWF” is used to indicate the image name, total number of pixels and dimensions and file extension name indicating an adobe “flash” type animation item. Pricing for this item [750] is referenced from a two dimensional list of prices that contains both a price range based on total pixels displayed and scalar categorized by the type of item. In the preferred method smaller image items with a static rendering type are priced less than larger items with embedded animation or video ad object types.

Again referring to FIG. 2, the second numerical value embedded in the ad identification ID (ADID) attribute [730] indicates the total number of days the particular item image will be run. This information is derived from user input preferably of form “data-type” as derived from the ad profile [220] containing the image or animation. In the preferred embodiment of the present method a single profile [220] may have a user defined runtime (subscription period). Wherein the runtime may be defined as the publication time period for a single advertising campaign. In the preferred embodiment the run-time is also referred to [225] as the subscription period. In alternate embodiments profiles may contain multiple runtimes and be classified as one of many subscription runtime periods. For example, in alternate embodiments “run for 30-days on weekends only” maybe specified as one component in the advertising identification ID [730] field. In yet another alternate embodiment the ADID attribute field may contain one or more indexes into at least one or more data tables. In the preferred embodiment the shorter the run time the higher the price for advertising profile (campaigns) publication. In the present method the run time multiplier [225] may be part of the (ADID) attribute [730] used for pricing of one or more profiles selected for publication. Thus, a pricing index based on the number of run-time days [760] may be used as part of the total pricing calculation [520]. The third dimension is based on the ad location [300]. This component of the attribute is dependent on the particular Internet access point where the ad is to be published. According to the present method of the preferred embodiment each network appliance contains a unit ID [305] wherein the unit ID is used to index one or more databases for correlation of the geographical access point location in which the profile item [220] will be published. Thus, in the preferred method the unit ID is typically embedded in the remote network appliance and retrieved by the server application for lookup for the physical location address and is also embedded as part of the ADID attribute.

In the present method physical locations with a high number of advertisers are considered “desirable locations” and are priced higher than locations with a lower number of advertisers. In addition there are other variables that enter into the pricing based on location desirability. Preferably, the present method uses not only the number of advertisers in a particular access point location but also the average number of Internet users per day, week or month along with other statistics such as specific demographics of the Internet access point. In some cases the method will categorized demographic information by examination of user Internet behavior. Use of the access point location information triggers the location price index [770] and is also a multiplier determining the final displayed pricing. Lastly, a scalar [710] is used to adjust for discount pricing or high-volume purchases. The scalar has a price index [780] that represents a plethora of input variables based on certain business arrangements such as agreements, contracts, partnerships and more. Thus, FIG. 2 illustrates how the total price [720] is determined by price indexes from fields contained within the ADID attribute [730]. In the preferred method it is calculated by multiplying the item price index1 & index2 [750] by the number of run days price index3 [760] by the location price index4 [770] and finally by the scalar price index5 [780]. The total price along with the total aggregated attribute from each ADID attribute is calculated and presented in the total accumulated price area of the system dashboard illustrated in FIG. 1. Alternate methods may use real scalar numbers to indicated the value of the indexes, wherein the scalar numbers are summed to achieve the total price of profile publications.

Although the present business method and invention has been described in considerable detail with reference to certain preferred versions thereof, other versions and variations are possible and contemplated. For example, the present business method has been illustrated in an embedded network device connected directly or indirectly to one or more wide area networks that serves DHCP protocol to one or more wireless or wire client computing devices connected to the network, but in actuality it is applicable to almost any computing device on the Local Area Network in a variety of configurations. In one embodiment the present invention may be programmed into one or more proxy servers that communicate directly between the Internet access points.

In the preferred business method the resellers or distributors are used in addition to hardware or semiconductor component manufactures for mass deployment on a global scale. Moreover, the present business method may be use for city wide free wireless distribution, public transportation locations, private hotels or reports or any number of other types of business establishments. Public or private organizations may deploy or have deployed network appliances with the present method described herein using the consideration from advertisements for the cost of initial deployment and continued maintenance. Also, in alternate embodiments the present method may be used “exclusively” to advertise or provide information for a single premise without any third party advertisements. The present business method prefers that revenues from on-line services are used to promote further deployment of the present business method providing a means to promote free wireless services to everyone possible. Also, the present business method is self-promoting, paid for by consideration of advertisers who are looking for alternative ways to expose other goods and services to the public. Finally, those skilled in the art should appreciate that they can readily use the disclosed conception and specific embodiments as a basis for designing or modifying other structures for providing the same purposes of the present invention without departing from the spirit and scope of the invention as defined by the following claims.

What is claimed is:

1: A business method that deploys premises based advertising wherein advertisers subsidize the cost of providing Internet access by publishing advertisements on one or more Local Area Networks within the premises, wherein;
said premises based advertising automatically places one or more advertising objects directly into one or more client computing devices connected to said Local Area Networks during the access and display of one or more Internet web-pages, and wherein;
advertising campaigns consist of the selection of one or more said advertising objects, and wherein;
each of said advertising objects contained within at least one said advertising campaigns is automatically assigned a monetary value independent from the number of times said advertising object is displayed.

2: The method of claim 1, wherein each of said advertising objects has a said monetary value that is independent from the number of times said advertising object is subsequently selected when at least one user of one or more said client computing devices clicks on said advertising object.

3: The method of claim 2, wherein publishing said advertising campaigns into said Local Area Networks is controlled by a single-page dashboard interface.

4: The method of claim 3, wherein said display and selection of at least one item in said dashboard interface results in the formation of one or more identification attributes used to hold selected components of said dashboard interface.

5: The method of claim 4, wherein said dashboard interface contains at least one or more display and selection areas used for uploading said advertising objects from one or more said client computing devices, and wherein;
Said identification attributes includes at least one said selected component with information to reference said advertising object.

6: The method of claim 5, wherein the final display resolution of said advertising object is used to determine the total monetary value of publishing one or more said advertising campaigns into one or more said premises.

7: The method of claim 4, wherein said dashboard contains at least one area for display and selection of one or more said advertising campaigns, and wherein;
at least one said identification attribute is used to identify the subscription period of one or more said advertising campaigns published into one or more said premises, and wherein;
said subscription period relates to the amount of time at least one said advertising campaign is published into at least one said premises, and wherein;
said subscription period is a said selected component used to derive the said total monetary value of publishing one or more said advertising campaigns into one or more said premises.

8: The method of claim 4, wherein said dashboard contains at least one map area for display and selection of physical locations that provide said premises based advertising on said local area networks, and wherein;
said physical locations have an average number of said client computing device connections per time period, and wherein;
said number of connections is used to derive the said total monetary value of publishing said advertising campaigns into one or more said premises.

9: The method of claim 4, wherein at least one additional monetary scalar is used to adjust said total monetary value of publishing one or more said advertising campaigns into one or more said premises.

10: The method of claim 4, wherein said dashboard contains at least one area for the display and selection to categorize one or more groups of similar business types.

11: The method of claim 10, wherein selection of one or more said groups of similar business types results in the display of all possible premises locations of said similar business types on said map area.

12: The method of claim 11, wherein said dashboard interface contains additional information showing the aggregated advertising campaign spending categorized by at least one or more competitive or said similar business types advertising in least one or more said premises locations.

13: The business method according to claim 2, wherein; said monetary value is used for financial consideration given to owners of said Local Area Networks for allowing said advertising campaigns to be published within said owners said premises.

14: The business method according to claim 2, wherein the total number of advertising objects displayed and the total number of said computing device clicks per time period are directly or indirectly reported through the said dashboard interface.

15: The business method according to claim 4, wherein said advertising objects, said advertising campaigns, said similar business types, and said total monetary value are tied together by a series of grouping actions carried out by the user during graphical manipulation of said dashboard interface, wherein;
said graphical actions use a drag and drop methodology to display, select and move said advertising objects into said advertising campaigns, and wherein;
said graphical actions also use said drag and drop methodology to display, select and move said advertising campaigns into one or more said premises displayed on said map area.

16: The business method according to claim 2, wherein the total aggregated price to publish one or more said advertising campaigns into one or more said premises is determined by the sum of the total price of each individual said advertising object selected.
